(19) United States
(12) Patent Application Publication
(10) Pub. No.: US 2025/0232267 A1
(43) Pub. Date: Jul. 17, 2025

(54) VIRTUAL DEVICES IN MANAGED ENVIRONMENTS

(71) Applicant: Ivanti, Inc., South Jordan, UT (US)

(72) Inventors: Alex Evans, Sandy, UT (US); David Brugneaux, Evry (FR)

(73) Assignee: Ivanti, Inc., South Jordan, UT (US)

(21) Appl. No.: 19/019,918

(22) Filed: Jan. 14, 2025

Related U.S. Application Data
(60) Provisional application No. 63/621,020, filed on Jan. 15, 2024.

(51) Int. Cl. G06Q 10/20; G06Q 10/0631

(52) U.S. Cl. CPC G06Q 10/20; G06Q 10/06311; G06Q 10/06312

(57) ABSTRACT

An embodiment includes a method of automated environment management using an analog environment device. The method involves generating a virtual device that represents the analog environment device by mapping a template to a digital form configured to receive manual input related to the device's attributes. Data received from the digital form is interpreted as coming from the virtual device and is normalized into a common format for system management. Based on the normalized data, the system determines if a defined condition exists in the environment related to the analog device or the environment itself. If such a condition is detected, the system triggers an automated action to address it.

### CROSS-REFERENCE TO RELATED APPLICATION

This application claims priority to and the benefit of U.S. Provisional Application No. 63/621,020, filed Jan. 15, 2024, which is incorporated herein by reference in its entirety.

### FIELD

The embodiments described in this disclosure are related to managed environments. In particular, some embodiments are directed to generation of virtual devices in managed environments that are representative of analog environment devices.

### BACKGROUND

An industrial environment such as a warehouse, a factory, a plant, may implement a management system to track operations and maintain the environment equipment. Operators in the industrial environment may be instructed to perform operations that involve changing locations of the items, adding items to the industrial environment, removing items from the industrial environment, etc. For example, the operators may move specific items to a loading dock responsive to receiving a request for procurement of the specific items. Some industrial environments may include operators performing manual tasks of movement of items within the industrial environment. Additionally or alternatively, industrial environments may include automated transportation of items through use of automated conveyors, pallet movers, cranes, etc.

An operator may use a portable computing device to facilitate the performance of the operations. For example, the operator may use a scanner device or a rugged device to electronically track addition and removal of items. Additionally, the operator may use a portable computer terminal to access information to help navigate the industrial environment. The portable computing device may be communicatively coupled to management systems as well as servers to implement management services and supply chain tracking of items.

In addition to the portable computing devices, some industrial environments include non-communicative equipment, which are referred to in the present disclosure as analog environment devices. The analog environment devices do not communicate information and data to the management systems. Accordingly, management of the analog environment devices does not occur or may occur in a separate or manual system. The failure to manage the analog environment devices and to integrate information related to the analog environment devices introduce inefficiencies into the industrial environments and may result in the analog environment devices persisting in an unmaintained state. Accordingly, there is a need in the field of managed environments to integrate analog environment devices into management systems.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention an embodiment includes a method of automated environment management including on an analog environment device. The environment includes a warehouse environment. The analog environment device includes a warehouse device that is not capable of digital communication with the system. The method may include generating a virtual device that is representative of an analog environment device. The generating may include mapping a template to at least a portion of a digital form that is configured to receive a manual input related to one or more attributes of an analog environment device. An example of the digital form may include an inspection checklist related to the analog environment device. Examples of the one or more attributes may include maintenance items of the analog environment device. An example of the defined condition may include a maintenance task of the analog environment device. The template provides logic that normalizes the data representative of the manual input such that the normalized data is substantially equivalent to digital data received by one or more digital environment devices. The method may include receiving data from the digital form. The data may be interpreted as received from the virtual device. The method may include normalizing data representative of the manual input entered into the digital form such that the data is formatted according to a common format that is available to a system implemented to manage an environment. The method may include aggregating the normalized data to generate a historical operational record of the analog environment device. The method may include determining that a defined condition exists in the environment based at least partially on the normalized data. The defined condition may be related to the analog environment device or related to the environment.

The defined condition may include a scheduled maintenance task, an acute maintenance task, a delay in an environment management operation, an unsafe environment condition, an inoperable state of the analog environment device, an inefficient operator, another defined condition, or some combination thereof. The method may include triggering in the system an automated action to address the defined condition responsive to the determination. The automated action may include placing the analog environment device out of service, initiating a task to replace the analog environment device, initiating a task to perform a maintenance operation, communicating an alert to a digital environment device, communicating a modification to an environment management operation, stopping operation of a digital environment device, modifying a scheduled environment management operation and communicating the modification to a digital environment device, another automated action or some combination thereof. The method may include receiving additional normalized data from a digital environment device. The determination of that the defined condition exists is based at least partially on the additional normalized data. The additional normalized data may include scan data from the environment that is indicative of item movement in the environment. The normalized data may be combined with the scan data to troubleshoot a cause of a pattern of behavior in the environment. The analog environment device may be used in the item movement in the environment. The pattern of behavior is at least partially attributable to the defined condition.

A further aspect of an embodiment may include non-transitory computer-readable medium having encoded therein programming code executable by one or more processors to perform or control performance of one or more of the operations of the methods described above.

An additional aspect of an embodiment may include compute device comprising one or more processors and a non-transitory computer-readable medium having encoded therein programming code executable by one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments of the present disclosure may be implemented;

FIG. 2 is a block diagram of an example automated environment management process (hereinafter, “process”) that may be implemented in the operating environment of FIG. 1 or another suitable environment;

FIG. 3 is a screenshot of an example form that may be implemented in the process of FIG. 2;

FIG. 4 is a screenshot of an example template summary interface that may be implemented in the process of FIG. 2;

FIG. 5 is a screenshot of an example form generation user interface (UX) that may be implemented in the process of FIG. 2;

FIG. 6 is a screenshot of an example form inventory that may be implemented in the process of FIG. 2;

FIG. 7 is a screenshot of an example template generation UX that may be implemented in the process of FIG. 2;

FIG. 8 is a screenshot of an example device inventory that may be implemented in the process of FIG. 2;

FIG. 9 is a screenshot of an example payload inspection UX that may be implemented in the process of FIG. 2;

FIG. 10 depicts an example automation scenario generation UX that may be implemented in the process of FIG. 2;

FIG. 11 illustrates an example computing system configured for automated environment management according to at least one embodiment of the present disclosure; and

FIG. 12 is a method of automated environment management, according to at least one embodiment of the present invention, all according to at least one embodiment described in the present disclosure.

### DESCRIPTION OF SOME EXAMPLE EMBODIMENTS

The embodiments described in this disclosure are related to managed environments. Some embodiments are directed to generation and incorporation of virtual devices into managed environments. The virtual devices represent analog environment devices (hereinafter, “analog devices”) in management systems and enable communication of data related to the analog devices to enable management of the analog devices and incorporation of data related to the analog devices in management services.

In conventional managed environments a subset of devices operating in the managed environment cannot be managed or are manually managed. Commonly, the subset of devices includes devices that do not have network communication capabilities. As a result, the subset of devices may persist in unmanaged states and/or the managed environment may implement a separate management system focused on the subset of devices. Data and information related to the subset of devices are not incorporated or integrated into datasets that include data from digital or network communication-capable devices. The embodiments of the current disclosure enable management of devices that are not capable of network or digital communication, which are referred to herein as analog digital devices, through generation of virtual devices. The virtual devices are incorporated in a management system such that the analog devices are treated as another other digital environment devices (hereinafter, “digital devices”). Accordingly, the analog devices are managed as part of the managed environment and data and information related to the analog devices may be analyzed as management services in the managed environment.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

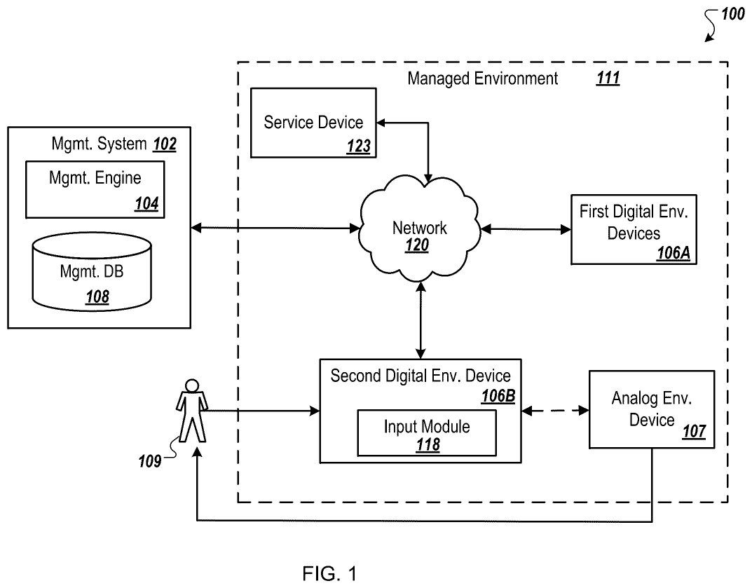

FIG. 1 is a block diagram of an example operating environment 100 in which some embodiments of the present disclosure may be implemented. In the operating environment 100, a virtual device may be generated that are representative of an analog device 107. Generation of the virtual device enables management of the analog device 107 and may enable incorporation of data related to the analog device 107 into a management system 102. In the depicted embodiment, the virtual device enables the analog device 107 to be managed similarly to digital devices 106A and 106B (generally, digital device 106 or digital devices 106). Accordingly, the management system 102 may analyze a managed environment 111 using both data received from the digital devices 106 and the analog device 107. For instance, the management system 102 may assess states of operations and equipment in the managed environment based on combined data from the digital devices 106 and the analog device 107. Moreover, in the managed environment 111 historical performance of the analog device 107 may be determined and tasks related to the analog device 107 may be automatically created and implemented.

In some embodiments, defined conditions may be created for the managed environment 111. The defined conditions include a set of states or data indicative of the set of states that trigger an action in the managed environment 111. For instance, the defined conditions may include a maintenance term for the analog device 107. A corresponding action that is triggered may include a task to perform a maintenance operation on the analog device 107. Additionally, inclusion of the virtual device that is representative of the analog device 107 enables the defined condition to be based on data received that relate to the analog device 107 or based on data received related to the analog device 107 combined with additional data received from one or more of the digital devices 106. Furthermore, the action triggered by the defined condition may be implemented relative to the analog device (as described above) or may be implemented at or by one or more of the digital devices 106. An example may be modification to a setting one of the digital devices 106 such as an IIOT device or modification to a sequence of screens displayed on a rugged device. In this example, the analog device 107 may include a forklift and the digital devices 106 may include an IIOT ventilation detector, an IIOT lighting control device, and a rugged device used for scanning operation of items in the managed environment 111, which may include a warehouse in this example. The defined condition may include a temperature at which the warehouse doors are closed, which may decrease lighting and ventilation in the warehouse. Accordingly, when the doors are closed, the action may include a control signal to increase the ventilation in the warehouse, to increase the warehouse lighting, and to cause display of a screen to an operator 109 to modify operation of the forklift to avoid a harmful ambient condition in the warehouse. Contents of the screen may be based on the type and operational attributes of the forklift.

The embodiments of the present disclosure represent a technical improvement to conventional systems. In conventional managed environments a subset of devices operating in the managed environment cannot be managed or are manually managed. Commonly, the subset of devices includes devices that do not have network communication capabilities. As a result, the subset of devices may persist in unmanaged states and/or the managed environment may implement a separate management system focused on the subset of devices. Data and information related to the subset of devices are not incorporated or integrated into datasets that include data from digital or network communication-capable devices. The embodiments of the current disclosure enable management of devices that are not capable of network or digital communication, which are referred to herein as the analog device 107, through generation of the virtual device. The virtual device is incorporated in a management engine 104 such that the analog device 107 is treated as another other digital device 106. Accordingly, the analog device 107 is managed as part of the managed environment 111 and data and information related to the analog device 107 may be analyzed as management services in the managed environment 111.

The operating environment 100 includes the management system 102, the digital devices 106, the analog device 107, and a server device 123, (collectively, “environment components”). At least some of the environment components may communicate data and information via a communication network 120 to enable generation and use of the virtual device. Each of the environment components are described in the following paragraphs.

The communication network 120 may include one or more wide area networks (WANs) and/or local area networks (LANs) that enable the environment components to communicate with one another. In some embodiments, the communication network 120 may include the Internet in which communicative connectivity between the components of the operating environment 100 is formed by logical and physical connections between multiple WANs and/or LANs. Additionally or alternatively, the communication network 120 may include one or more cellular radio frequency (RF) networks, one or more wired networks, one or more wireless networks (e.g., 802.xx networks), Bluetooth access points, wireless access points, Internet Protocol (IP)-based networks, or any other wired and/or wireless networks. The communication network 120 may also include servers that enable one type of network to interface with another type of network.

The analog device 107 includes a physical device or object. The analog device 107 may include a hardware-based computing device or may include a mechanical device without a hardware-based computing device. The analog device 107 is not configured to or not capable of communication of data via the network 120. For example, the analog device 107 may be a “dumb” device that does not include a communication unit that is communicatively coupled to the management system 102 via the network 120. Some examples of the analog device 107 may include forklifts, pallet jacks, stackers, reach trucks, tow tractors, lifts, conveyor belts, cranes, doors, etc.

In some embodiments, the analog device 107 may have affixed to it a barcode or another suitable matrix having encoded data. The encoded data might include information related to the analog device 107, which may be pulled by scanning the matrix.

The digital devices 106 may include hardware-based computing systems that are configured to communicate with at least some of the other environment components via the communication network 120. The digital devices 106 may include a computing device configured to perform operations in the managed environment 111. For instance, the digital devices 106 may include a scanner device, a rugged device, an IIOT device, a sensor deployed in the managed environment 111, an IIOT sensor, or a mobile or smart device, which may include a scanner. In some embodiments, the digital devices 106 may be computer devices used in an industrial setting, such as a warehouse environment. The digital devices 106 may include a user interface that is configured to receive manual input from the operator 109. Some examples of the user interface may include an audio microphone, a touch screen, a keyboard, etc.

The digital devices 106 may include an input module 118. For instance, in FIG. 1, the second digital device 106B includes the input module 118 and the first digital device 106A does not. The input module 118 is configured to receive or access a digital form that is related to the analog device 107. The input module 118 enables input of data and information into the digital form, which may be communicated to the management engine 104. In some embodiments, the input module 118 may cause the display of the digital form (e.g., on a display device of the second digital device 106B). The input module 118 may receive manual input (e.g., via a user interface) from the operator 109. The input module 118 may communicate data representative of the manual input to the management engine 104. Additionally or alternatively, the second digital device 106B may be configured to scan a matrix or barcode affixed to the analog device 107 to at least partially provide input to the input module 118, which is then communicated to the management system 102. Additionally still, in some embodiments the input module 118 may interface with one or more other systems of the digital device 106. For instance, the operator 109 may log into the second digital device 106B by providing credentials such as a username and password. The input module 118 may pull employee information from another system of the second digital device 106B.

The second digital device 106B may be implemented to provide information regarding attributes of the analog device 107. For instance, the operator 109 may operate the second digital device 106B to provide input to the input module 118. In some embodiments, the operator 109 may use the input module 118 to pull and display the digital form related to the analog device 107. The operator 109 may enter values into the digital form for the attributes related to the analog device 107. The input module 118 may communicate the digital form with the values of the attributes to the management engine 104.

In addition, the digital devices 106 may communicate additional data related to the managed environment 111 to the management engine 104. The additional data may be representative of physical phenomena in the managed environment 111. Additionally or alternatively, the additional data may include data related to movement and management of items in the managed environment 111. For instance, the digital devices 106 may include rugged devices with scanners. As the operator 109 moves items around the managed environment 111, the operator 109 may scan the items. Data representative of the location and item identifiers may be included in the additional data.

The second digital device 106B may be associated with the operator 109. The operator 109 may be an individual, a set of individuals, or a computer system that interfaces with the second digital device 106B. In some embodiments, the operator 109 may provide input to the second digital device 106B related to the analog device 107.

In addition, the operator 109 may perform tasks in the managed environment 111 that may be related to environment management operations of the management engine 104. The operator 109 may perform the task using the second digital device 106B and the environment management operations may initiate and/or guide the operator 109 as the task is performed. For instance, the tasks may include picking, packing, moving, receiving, or loading items in the managed environment 111. Associated with these and other tasks may be environment management operations that guide the operator 109 through the task. The environment management operations or representations thereof may be displayed on the second digital device 106B in a series of screens.

The server device 123 includes a hardware-based computing device. The server device 123 may be a centralized repository and management program that communicates data with at least some of the digital devices 106. The server device 123 and at least some of the digital devices 106 may be included in a supply chain management network within the managed environment 111. The supply chain management network may be implemented to track items as they move through a supply chain such as from a manufacture facility to a warehouse, then to a delivery truck, and then to a store or within a store from a warehouse to a shelf and then to a consumer. In these and other embodiments, the additional data may be communicated to the server device 123 as well as the management engine 104. The additional data may be communicated using a telnet protocol. For instance, the server device 123 may be configured as a telnet server in these and other embodiments.

The digital devices 106 may include a user interface into which information is entered. For instance, the digital devices 106 may include a scanner device, which enters information into the user interface by scanning a barcode or another encoded matrix. The information from the scanner device may be communicated as the additional data to the server device 123 and/or the management engine 104. The additional data may be communicated via the communication network 120. Additionally, in some embodiments at least a portion of the digital devices 106 may communicate a portion of the additional data via a dedicated wired communication network.

In some embodiments, the managed environment 111 may not include the server device 123. Additionally, in the depicted embodiment, the server device 123 is included in the managed environment 111. In other embodiments, at least a portion of the server device 123 may not be included in the managed environment 111.

The management system 102 may include hardware-based computing system that is configured to communicate with at least some of the other environment components via the communication network 120. In some embodiments, the management system 102 may be a single server, a set of servers, a virtualized system, or a virtualized server in a cloud-base network of servers. In these and other embodiments, the management engine 104 and a management database (in the Figures “Mgmt. DB”) 108 may be spread over two or more cores, which may be virtualized across multiple physical machines, and/or over multiple memory banks.

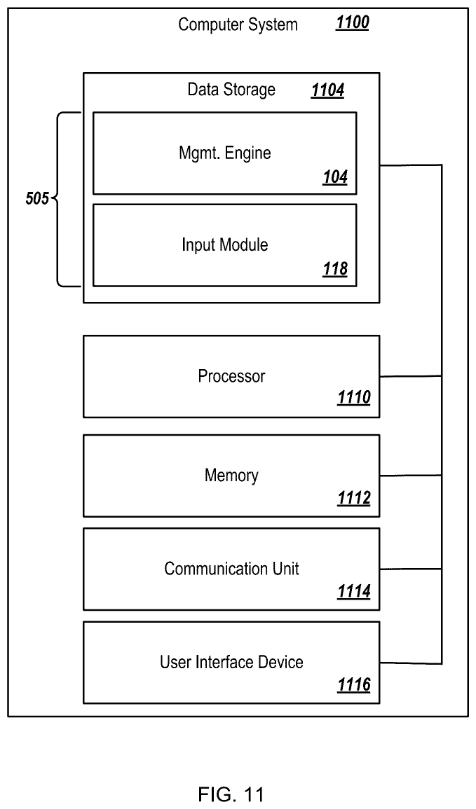

The management database 108 may be configured to store data representative of input received from the input module 118. The management database 108 may include computer-readable storage media for carrying or having computer-executable instructions or data structures stored thereon (e.g., memory 1112 of FIG. 11). The data representative of the input may be stored such that it is accessible to the management engine 104. In some embodiments, the data representative of the input may be used to generate a historical operational record of the analog device 107. Additionally or alternatively, the data stored in the management database 108 may be used by the management engine 104 to determine whether defined conditions exist in the managed environment 111.

The management engine 104 may provide productivity management network to the managed environment 111. The productivity management network is implemented with the managed environment 111 to improve usability and efficiency of the operations. The productivity management network may be deployed “on top of” the supply chain management network. For instance, in the supply chain management network, the server device 123 and/or software implemented thereon or thereby may centrally track additional data input from digital devices 106. The supply chain management network may implement a telnet protocol (e.g., Telnet) or another similar data communication protocol (collectively, telnet protocols) as a basis of data communication between the digital devices 106 and the server device 123. The telnet protocols may have limited functionality such as uncommon or user-hostile user interface functionality, restricted data entry functionality, and rigid display features. To improve data communication via telnet protocols, the productivity management system may be implemented. The productivity management system may improve the user interface, optimize data entry, and improve display features and functions. Additionally, the productivity management system may harvest and process data entered during performance of the operations to provide metrics, recommendations, and oversight regarding operational efficiency.

The management engine 104 may be configured to perform automated environment management of the managed environment 111 that includes the analog device 107. In some embodiments, the managed environment 111 may include a warehouse environment or an industrial environment that is managed by the management system 102. The management engine 104 may generate the virtual device that is representative of the analog device 107. For example, the management engine 104 may map a template to at least a portion of a digital form that is configured to receive input related to one or more attributes of the analog device 107. The digital form may include an inspection checklist related to the analog device 107, for instance. The one or more attributes may include maintenance items of the analog device 107 in these and other embodiments. The management engine 104 may normalize the data representative of the input entered into the digital form. Normalization may change the data such that it is formatted according to a common format that is available to the management system 102. In some embodiments, the template provides computer logic that normalizes the data representative of the input. The computer logic of the template is configured such that the normalized data is substantially equivalent to additional data received by one or more digital devices 106. The management engine 104 may receive additional normalized data. The additional normalized data may be normalized forms of the additional data received from the digital devices 106. Some examples of the additional normalized data include scan data from the managed environment 111 that is indicative of item movement, sensor data received from an IIOT device, other additional data, or combinations thereof.

The management engine 104 may determine that a defined condition exists in the managed environment 111. The determination may be based at least partially on the normalized data. Additionally, the management engine 104 may combine the normalized data with the additional normalized data. In these and other embodiments, the determination of whether the defined condition exists may be based on a combination of the normalized data and the additional normalized data. For example, the management engine 104 may use the combination of the normalized data and the additional normalized data to troubleshoot a cause of a pattern of behavior in the managed environment 111. The defined condition may be related to the analog device 107 or may be related to another aspect of the managed environment 111. Some examples of the defined condition include a maintenance task of the analog device 107, a scheduled maintenance task, an acute maintenance task (e.g., due to a mechanical failure), a delay in an environment management operation such as delays in processes in a supply chain operation, an unsafe environment condition, an inoperable state of the analog device 107, an inefficient operator, other defined conditions, or combinations thereof.

Responsive to the determination that the defined condition exists, the management engine 104 may trigger in the managed environment an automated action. The automated action may be configured to address or mediate the defined condition. Some examples of the automated action may include placing the analog device 107 out of service, initiating a task to replace the analog device 107, initiating a task to perform a maintenance operation, communicating an alert to one or more of the digital devices 106, communicating a modification to an environment management operation, stopping operation of one or more of the digital devices 106, modifying a scheduled environment management operation and communicating the modification to one or more of the digital devices 106, another automated action, or combinations thereof. The management engine 104 may aggregate the normalized data. Aggregation of the normalized data may be used to generate a historical operational record of the analog device 107.

The management engine 104, the input module 118, and components thereof may be implemented using hardware including a processor, a microprocessor (e.g., to perform or control performance of one or more operations), a field-programmable gate array (FPGA), or an application-specific integrated circuit (ASIC). In some other instances, the management engine 104, the input module 118, and components thereof may be implemented using a combination of hardware and software. Implementation in software may include rapid activation and deactivation of one or more transistors or transistor elements such as may be included in hardware of a computing system (e.g., the digital devices 106, the server device 123, or the management system 102 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more devices 106 and 107, one or more management systems 102, one or more server devices 123, one or more managed environments 111, one or more networks 120, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

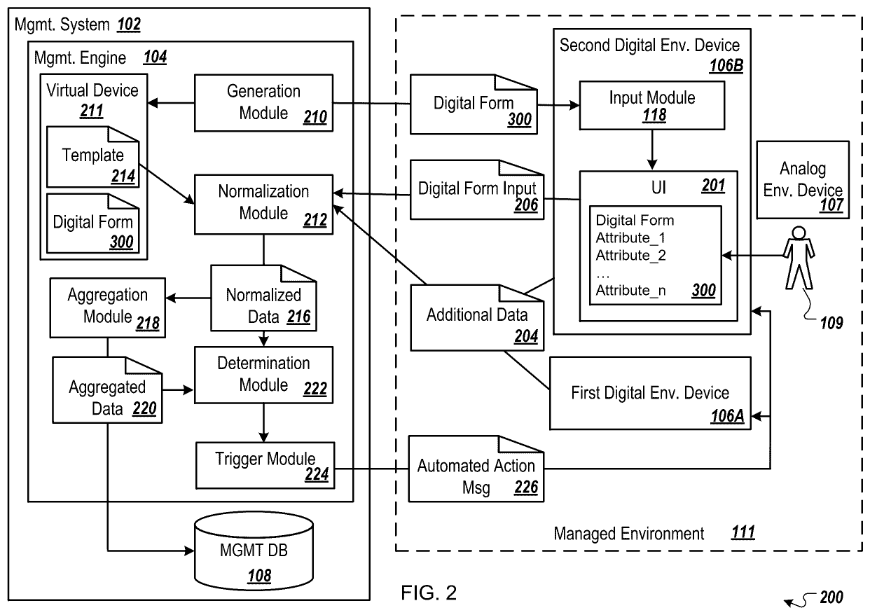

FIG. 2 is a block diagram of an example automated environment management process (hereinafter, “process”) 200 that may be implemented in the operating environment 100 of FIG. 1 or another suitable environment. FIG. 2 includes some of the components (e.g., 102, 104, 106, 111, 108, 118, etc.) described with reference to FIG. 1. Communication of data and information included in the process 200 may be via a communication network such as the network 120 described with reference to FIG. 1.

The process 200 may begin with generation of a virtual device 211. For instance, the management engine 104 may include a generation module 210 that is configured to generate the virtual device 211. The virtual device 211 is representative of the analog device 107.

For instance, an example of the management system 102 may include Ivanti Neurons® for IIOT. In this example, the digital devices 106 may include IIOT devices and rugged devices implemented in a warehouse or another suitable environment. The digital devices 106 may be discovered and/or interfaced with via network communication. Each of the digital devices 106 may be included in a database of devices managed in the managed environment 111. Data received from the digital devices 106 (in FIG. 2, “additional data 204”) may be normalized such that the data may be analyzed and processed by the management system 102. The management system 102 may create files and logical representation of devices that are visible to an administrator. Generation of the virtual device 211 creates a virtual representation of the analog device 107. The virtual device 211 is substantially similar to the digital devices 106. For instance, data from the analog device 107 (as described elsewhere herein) is processed and normalized such that it can be analyzed with the additional data 204 received from the digital devices 106. The generation of the virtual device 211 may create a logical representation of the analog device 107 in a set of devices 106 and 107 that are managed by the management system 102.

To generate the virtual device, the generation module 210 may map a digital form 300 to a template 214. The template 214 may be created for the analog device 107 or the template 214 may be a generic template that applies to two or more analog devices 107 of a similar type. For instance, the template 214 may be applicable to two or more forklifts, two or more automobiles, two or more conveyor belts, etc.

The template 214 may include template parts that relate input to the digital form 300. For instance, the digital form 300 may include multiple fields that are configured to receive information. The template 214 assigns one of the template parts to one or more of the fields of the digital form 300. The template parts attach processing guides such as meaning, format, data type, expected payload, etc. to the fields. Accordingly, the virtual device is populated by input received via the digital form 300 as interpreted by the template 214.

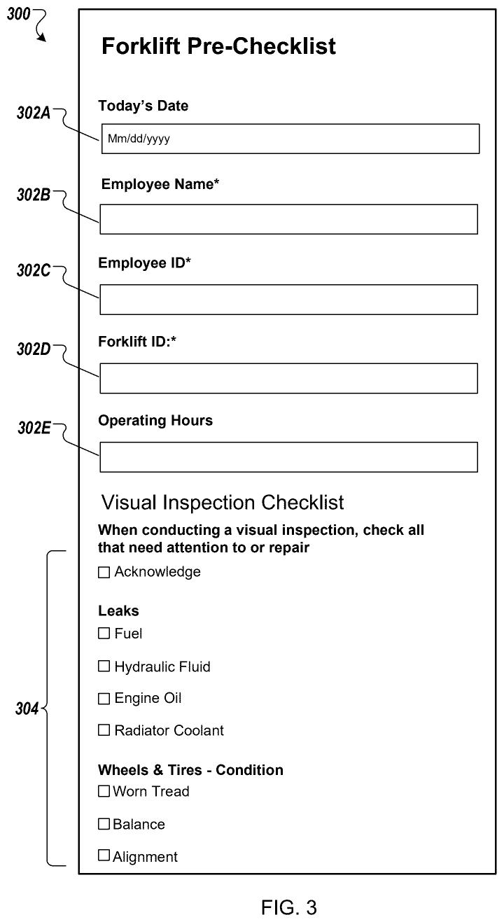

The digital form 300 may be communicated to or be accessible to the input module 118. An example of the digital form 300 is described with reference to FIG. 3. The input module 118 may display or cause the display of the digital form 300 in a user interface (UI) 201 of the second digital device 106B. Input may be entered into the digital form 300. For instance, the operator 109 may provide input to the UI, which is received into one or more fields of the digital form 300. Additionally, the input module 118 may pull information from other systems of the second digital device 106B and/or information may be entered through a scan operation performed by the second digital device 106B.

The input module 118 may communicate digital form input 206 to a normalization module 212 of the management engine 104. The management engine 104 may include the normalization module 212. The normalization module 212 may be configured to receive the digital form input 206 from the second digital device 106B and additional data 204 from the digital devices 106. The normalization module 212 may be configured to normalize the additional data and data representative of the digital form input 206. Normalization operations may include changes to a format of the digital form input 206 such that normalized data representative of the digital form input 206 is available to the management engine 104 and components thereof.

Additionally, in some embodiments, the normalization module 212 may be configured to receive and normalize the additional data 204. In these and other embodiments, the normalization operations include application of computer logic that changes the additional data 204 and the data representative of the digital form input 206 to a common format that is available to the management system 102.

In some embodiments, the normalization module 212 may receive the template 214. The template 214 may form the basis of the normalization operations applicable to the data representative of the digital form input 206. For instance, the template 214 provides computer logic that normalizes the data representative of the digital form input 206. The computer logic may be configured such that normalized data 216 output from the normalization module 212 that originated at the digital form 300 is substantially equivalent to normalized versions of the additional data 204. The normalization module 212 may output normalized data 216 to a determination module 222 and an aggregation module 218.

The aggregation module 218 may be configured to aggregate the normalized data 216 to generate the aggregated data 220. The normalized data 216 may be aggregated to generate a historical operational record of the analog device 107. The aggregation module 218 may be communicated to the determination module 222 and to the management database 108. The aggregated data 220 may be stored in the management database 108.

The determination module 222 may be configured to determine whether a defined condition exists in the managed environment 111. The determination may be the based at least partially on the normalized data 216. The normalized data 216 may include a first portion that includes normalized data that represents the digital form input 206 and a second portion that includes additional normalized data that represents the additional data 204.

The defined condition may include a set of circumstances that exist in the managed environment 111 that may be addressed or mitigated by the management engine 104. The defined condition may be related to the analog device 107, a pattern of behavior or occurrences in the managed environment 111, may be related to the managed environment 111 or portions thereof. For instance, the defined condition may include a maintenance task related to the analog device 107, a scheduled maintenance task related to the analog device 107, an acute maintenance task related to the analog device 107, a change in pace (e.g., a delay, a quicker pace, etc.) in an environment management operation, an unsafe environment condition, an inoperable state of the analog device 107, an inefficient operator, an inefficient process, other defined conditions, or combinations thereof.

For instance, the defined condition may include a pattern of movement of particular items in the managed environment 111. The additional normalized data (e.g., normalized versions of the additional data 204) may include scan data that is indicative of the movement of the particular items in the managed environment 111. The movement may include operation of the analog device 107. The normalized data 216 may be combined with the scan data to troubleshoot and analyze the pattern. The pattern may be determined to be an inefficient process, which may trigger an automated action.

The trigger module 224 may be configured to trigger an automated action. The automated action is triggered in response to a determination that a defined condition exists in the managed environment 111. The automated action addresses or mitigates the defined condition in the managed environment 111. The automated action may include communication of an automated action message (in the Figures “automated action msg.”) 226. The automated action message 226 may include a control signal that modifies a state of one of the digital devices 106. For instance, the automated action message 226 may include a change to screens displayed on the second digital device 106B or inclusion of an additional screen displayed on the second digital device 106B. The additional screen may include a notice to the operator to place the analog device 107 out of service or to replace a component of/perform a maintenance operation of the analog device 107. Additionally or alternatively, the automated action message 226 may communicate a control signal that modifies a set point or operational range of the first digital device 106A, which may be an IIOT sensor or an IIOT actuator. Additionally or alternatively, in some embodiments, the automated action message 226 may include an alarm or an alert. The alarm or the alert may indicate to individuals in the managed environment 111 of an unsafe condition. The alarm may accompany a control signal that stops operation of another component in the managed environment 111.

For instance, the analog device 107 may include a forklift. The defined condition may include replacement of hydraulic fluid every 200±5 hours of operation. The normalized data 216 indicates that the forklift has been in operation 196 hours at the beginning of a shift. Four hours into the shift, the automated action message 226 may be communicated to the second digital device 106B. The automated action message 226 may direct the operator to leave the forklift at the maintenance facility and schedule the task with maintenance personnel or maintenance system. In addition, in response to operation of the forklift exceeding the maximum limit, the automated action message 226 may cease operation of the second digital device 106B, which may prevent further operation of the forklift.

In another example, the analog device 107 includes a forklift and defined condition may include a pattern of slower than expected picking by an operator that is using the forklift. The normalized data may indicate that the forklift is at the end of its life, which may be contributing to the slow pace. The automated action message 226 may direct the operator to leave the forklift at the maintenance facility and schedule the task to replace the forklift. Additionally or alternatively, the automated action message 226 may modify an expected pace for the picking operation. Modifications to the expected pace may permeated through the system, which may change scheduled times for deliveries and pick up of items as well as delivery times for items. Additionally or alternatively, the automated action message 226 may change a sequence in which items are picked in the managed environment 111, which may increase the slow pace. Modifications to the sequence may modify a sequence of screens displayed on the second digital device 106B.

FIG. 3 is a screenshot of an example digital form 300 that may be implemented in the process 200 of FIG. 2. The digital form 300 may be displayed on a digital device such as the digital device 106 described elsewhere in the present disclosure.

The digital form 300 includes multiple fields 302A-302E (generally, field 302 or fields 302) and a checklist 304. Data may be entered into the fields 302 and the checklist 304 using the digital form 300. The data is communicated to a management system such as the management system 102. The fields 302 may be filled in manually, by pulling data from the digital device, or by pulling information from an encoded source. For instance, an operator may provide input to the digital form 300 by selecting or typing into a user interface of the digital device. Additionally or alternatively, an operator may log into the digital device. The digital form 300 may pull log in credentials or user identifying information from digital device. Additionally or alternatively, at least some of the data may be entered via a scan of a code affixed to the analog device (e.g., the forklift). For instance, in the depicted embodiment, the digital form 300 is generated for a forklift, which is an example of the analog device 107. The forklift may have a barcode affixed to it, which may be scanned by a rugged device to enter data into one or more of the fields of the digital form 300. The checklist 304 may include a set of items to inspect. A checkbox is provided to allow an operator to confirm that they have performed the inspection.

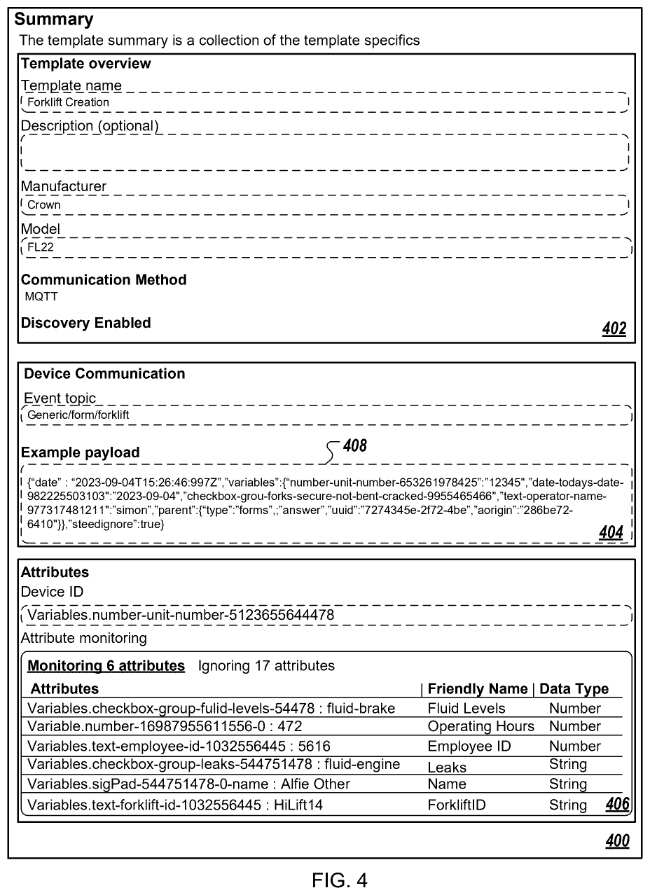

FIG. 4 is a screenshot of an example template summary interface (summary interface) 400 that may be implemented in the process 200 of FIG. 2. The summary interface 400 depicts information related to data mapped between a corresponding template and a digital form such as the digital form 300 of FIG. 3. The summary interface 400 includes an overview of the template in a first interface portion 402. For instance, the first interface portion 402 includes a template name, a description, a manufacture, a model, a communication method, and whether discovery is enabled or disabled. Accordingly, a corresponding template that is summarized by the summary interface 400 is named “Forklift creation” is manufactured by Crown, is a FL22 model, and a communication protocol implemented by the corresponding template is message queuing telemetry transport (MQTT) protocol. Additionally, according to the summary interface 400, the Crown FL22 forklift is discoverable.

In a second portion 404, device communication information is provided. The device communication information may include a source of the information and an example of data that is based on the form. For example, in the second portion 404, an event topic and an example payload field 408 are provided. The event topic indicates that the data related to the forklift is provided by a form. In the depicted example, the corresponding form is a generic form for a forklift.

The example payload field 408 depicts an example of a payload of input received. The payload is representative of input received in a corresponding form. In the example of FIG. 4, the payload includes inputs related the “date” fields and “variables” fields, operator identifiers, network locations or addresses of digital devices that submit the form, etc.

A third interface portion 406 provides attributes of the corresponding template. The third interface portion 406 includes a device ID that is assigned to the virtual device of the Crown FL22 forklift in the depicted example. Additionally, a set of attributes of the digital form are listed in the third interface portion 406. The set of attributes is divided between those attributes that are monitored and input into the system and those attributes that are not monitored. In the depicted embodiment, the attributes that are monitored include fluid levels, operating hours, etc. The data type of each of the monitored attributes is also listed.

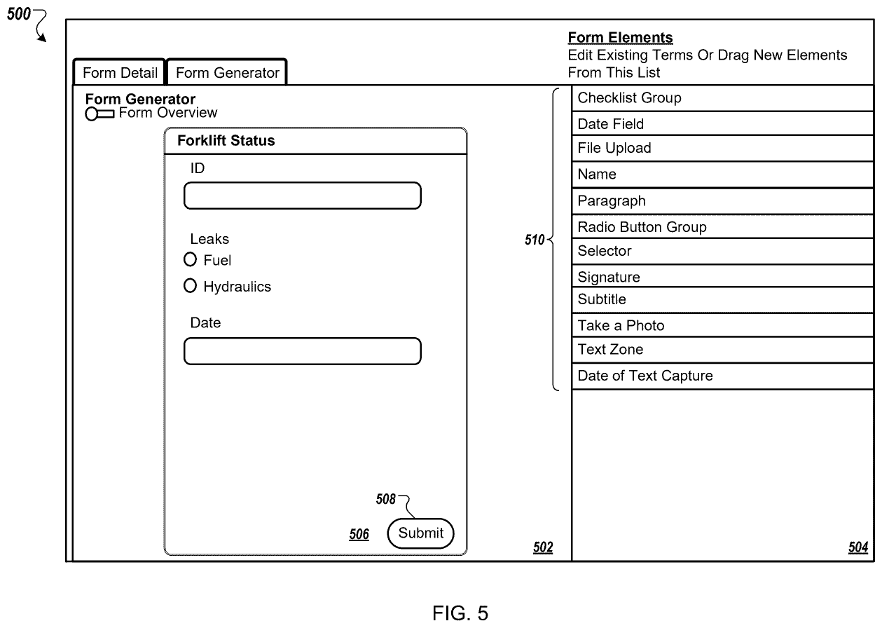

FIG. 5 is a screenshot of an example form generation UX 500. The form generation UX 500 includes a form generation portion 502 and an available field portion 504. In the form generation portion 502, a form 506 is displayed. A user may drag fields 510 from the available field portion 504 onto the form 506 to generate a field into which input is entered. For instance, if the form 506 is to include a “name” field, then a user drags the “name” field (510) from the available field portion 504 onto the form 506. After the form 506 is complete, selection of a submit button 508 generates the form.

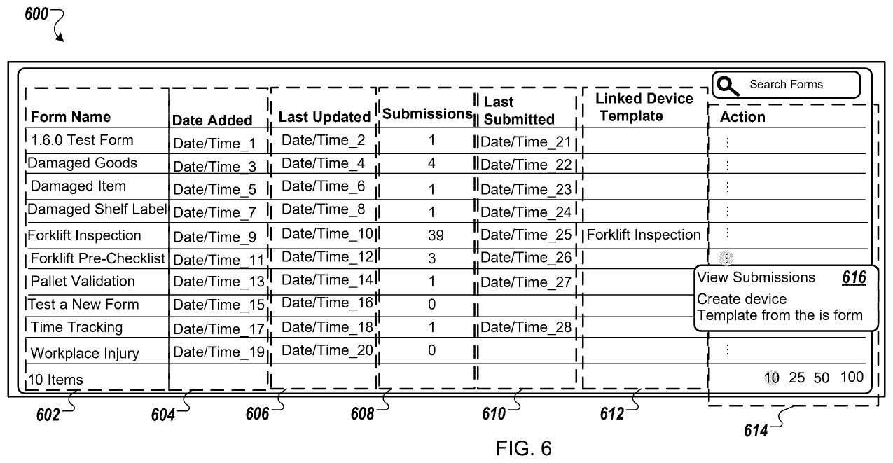

FIG. 6 is a screenshot of an example form inventory 600. The form inventory 600 includes forms 602 that are utilized by a management system such as the management system 102 described elsewhere in the present disclosure. Selection of the submit button 508 of FIG. 5 publishes the form 506 to the form inventory 600. Associated with each of the forms 602 is information that are organized in columns. The columns in the form inventory 600 include a data added 604, a last (most recent) update 606, a number of submissions using the form 608, a date of a last (most recent) submission 610, and whether there is a linked template 612. A final column 614 includes an “action” column. Selection of the ellipse in the final column 614 opens a sub-window 616 in which a “create device template form from this form” option is displayed. Selection of this option enables generation of a template that is linked to the corresponding form.

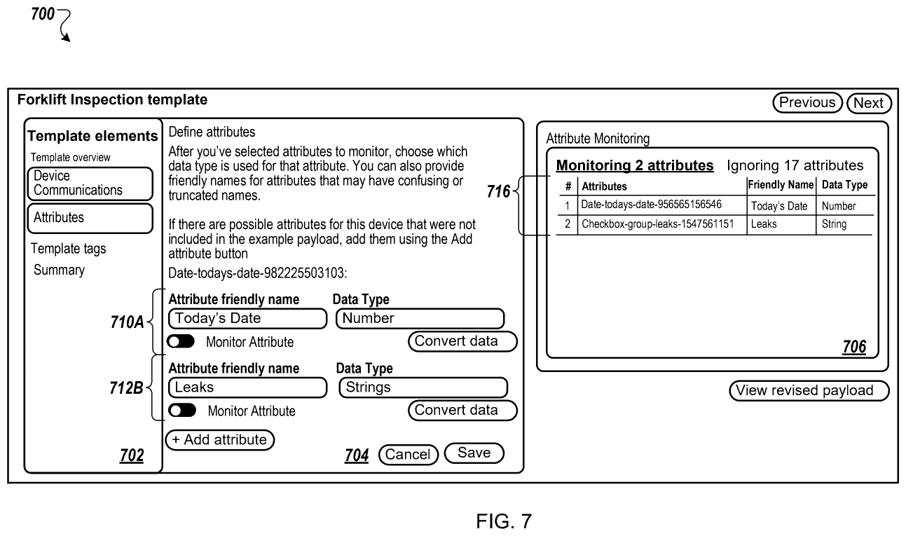

FIG. 7 is a screenshot of an example template generation UX 700. The template generation UX 700 includes a template element portion 702, a definition portion 704, and an attribute monitoring portion 706. In the template element portion 702, selection of elements, namely “device communication,” “attribute,” and “template tags” may be selected. After a selection is made, the definition portion 704 is displayed. Attribute definitions 710A and 710B may be displayed for one or more attributes. For instance, in the depicted embodiment, a name may be included, and a data type may be selected for the attribute. Additionally, whether the attribute is monitored may be selected. In the attribute monitoring portion 706, the attributes, friendly name, and data type are displayed in an attribute list 716.

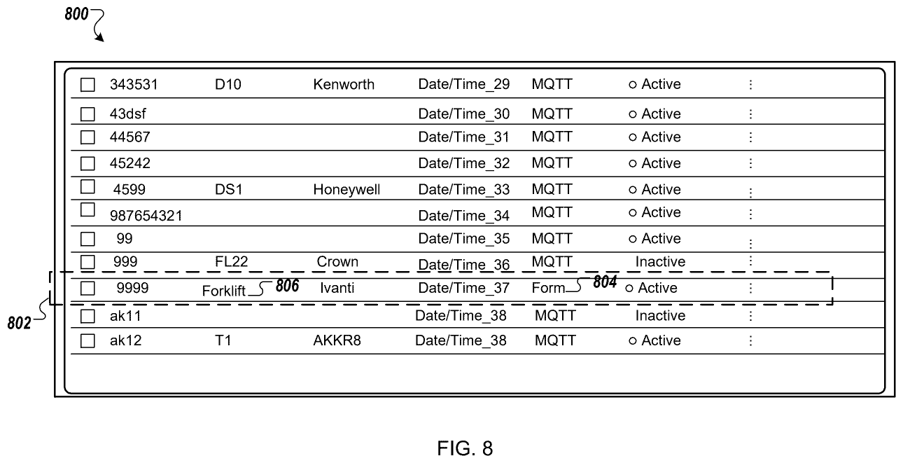

FIG. 8 is a screenshot of an example device inventory 800. After the template is generated and mapped to a form, an analog device is included in the device inventory 800. For instance, the depicted screenshot, a forklift entry 802 is included. The forklift entry 802 includes a name of the analog device 806 and a data source or format 804 of the data related to the forklift entry 802 is displayed. In the depicted example, the data source or format 804 is “Form” indicating that the source of data related to the forklift is a form.

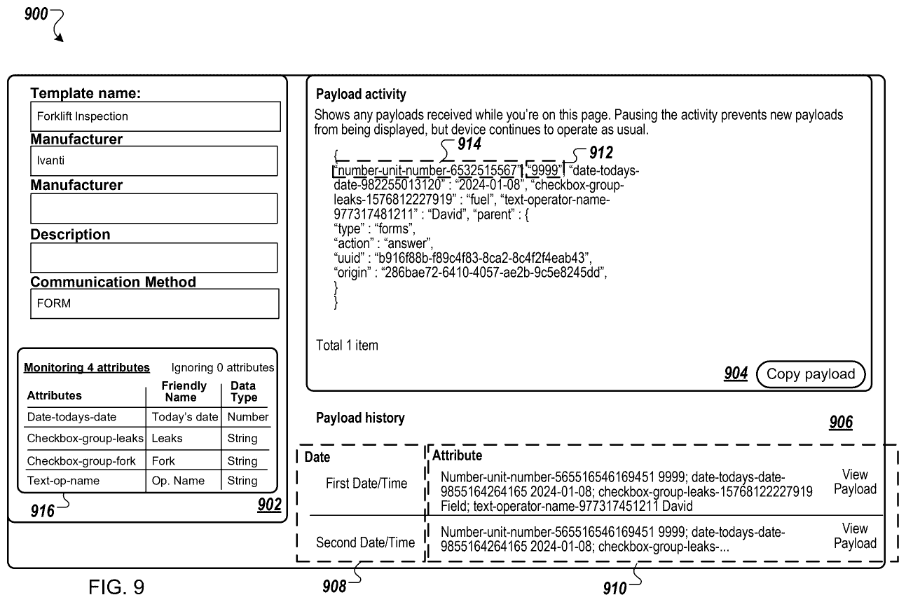

FIG. 9 is a screenshot of an example payload inspection UX 900. The payload inspection UX 900 enables inspection of a payload that is received at a corresponding template. For instance, the payload inspection UX 900 includes a template data portion 902. The template data portion 902 includes fields associated with the template from which payloads are received. For instance, the template data portion 902 includes a template name, a manufacture, a description, and a communication method. The communication method in this example is “FORM” indicating that a source of the payload is a form. Additionally, in the template data portion 902 a monitored attributes window 916 is displayed. The monitored attributes window 916 includes a list of attributes that are actively monitored related to the template. In the depicted example, four (4) attributes are monitored, which are listed, and 0 attributes are ignored. The payload inspection UX 900 includes a payload activity portion 904. The payload activity portion 904 displays activity such as receipt of a payload as form input while a user is viewing the payload activity portion 904. In the payload activity portion 904, attribute names and numbers 914 are followed by values 912 input to a form. For instance, in FIG. 9, “number-unit-number-653261978425” is the attribute and a value “9999” is the payload received for the attribute. The payload inspection UX 900 may include a payload history portion 906. The payload history portion 906 includes dates 908 of form submission and a list of the values 910 of attributes received on the corresponding date 908.

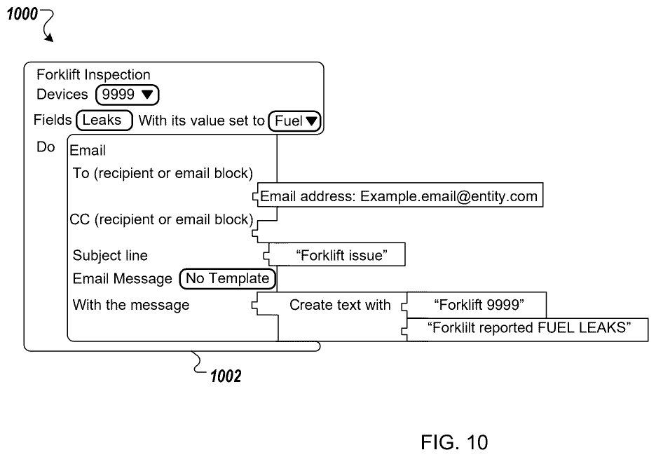

FIG. 10 depicts an example automation scenario generation UX 1000. The automation scenario generation UX 1000 enables creation of an automated action and definition of one or more triggers for the automated action. The automation scenario generation UX 1000 includes a graphic user interface (GUI) 1002 that enables a low code/no code definition of parameters of the automated action. For instance, the GUI 1002 allows for definition of the device, in this example the device is defined as “9999.” The GUI 1002 defines which fields trigger the action. In this example, the fields are “leaks” with its value set to “Fuel”. Accordingly, responsive to the value of a field “leaks” being “fuel” the automated action may be triggered. The GUI 1002 also defines the automated action in a “DO” section. The “DO” section in this example is communication of an email to a particular address, with particular information included. In this example, the automated email is sent to “example.email@entity.com” with a “subject line” of “Forklift issue” and a text of “forklift 9999” and “Forklift reported FUEL LEAKS.”

FIG. 11 illustrates an example computing system 1100 configured for automated environment management in managed environments that include virtual devices according to at least one embodiment of the present disclosure. The computing system 1100 may be implemented in the operating environment 100 of FIG. 1 or another suitable operating environment. Examples of the computing system 1100 may include the digital devices 106, the management system 102, the server device 123, or some combination thereof. The computing system 1100 may include one or more processors 1110, a memory 1112, a communication unit 1114, a user interface device 1116, and a data storage 1104 that includes the management engine 104 and the input module 118 (collectively, modules 1105).

The processor 1110 may include any suitable special-purpose or general-purpose computer, computing entity, or processing device including various computer hardware or software modules and may be configured to execute instructions stored on any applicable computer-readable storage media. For example, the processor 1110 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 11, the processor 1110 may more generally include any number of processors configured to perform individually or collectively any number of operations described in the present disclosure. Additionally, one or more of the processors 1110 may be present on one or more different electronic devices or computing systems. In some embodiments, the processor 1110 may interpret and/or execute program instructions and/or process data stored in the memory 1112, the data storage 1104, or the memory 1112 and the data storage 1104. In some embodiments, the processor 1110 may fetch program instructions from the data storage 1104 and load the program instructions in the memory 1112. After the program instructions are loaded into the memory 1112, the processor 1110 may execute the program instructions.

The memory 1112 and the data storage 1104 may include computer-readable storage media for carrying or having computer-executable instructions or data structures stored thereon. Such computer-readable storage media may include any available media that may be accessed by a general-purpose or special-purpose computer, such as the processor 1110. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 1110 to perform a certain operation or group of operations.

The communication unit 1114 may include one or more pieces of hardware configured to receive and send communications. In some embodiments, the communication unit 1114 may include one or more of an antennae, a wired port, and modulation/demodulation hardware, among other communication hardware devices. In particular, the communication unit 1114 may be configured to receive a communication from outside the computing system 1100 and to present the communication to the processor 1110 or to send a communication from the processor 1110 to another device or network (e.g., the network 120 of FIG. 1).

The user interface device 1116 may include one or more pieces of hardware configured to receive input from and/or provide output to a user. In some embodiments, the user interface device 1116 may include one or more of a speaker, a microphone, a display, a keyboard, a touch screen, or a holographic projection, among other hardware devices.

The modules 1105 may include program instructions stored in the data storage 1104. The processor 1110 may be configured to load the modules 1105 into the memory 1112 and execute the modules 1105. Alternatively, the processor 1110 may execute the modules 1105 line-by-line from the data storage 1104 without loading them into the memory 1112. When executing the modules 1105, the processor 1110 may be configured to perform one or more processes or operations described elsewhere in this disclosure.

Modifications, additions, or omissions may be made to the computing system 1100 without departing from the scope of the present disclosure. For example, in some embodiments, the computing system 1100 may not include the user interface device 1116. In some embodiments, the different components of the computing system 1100 may be physically separate and may be communicatively coupled via any suitable mechanism. For example, the data storage 1104 may be part of a storage device that is separate from a device, which includes the processor 1110, the memory 1112, and the communication unit 1114, that is communicatively coupled to the storage device. The embodiments described herein may include the use of a special-purpose or general-purpose computer including various computer hardware or software modules, as discussed in greater detail below.

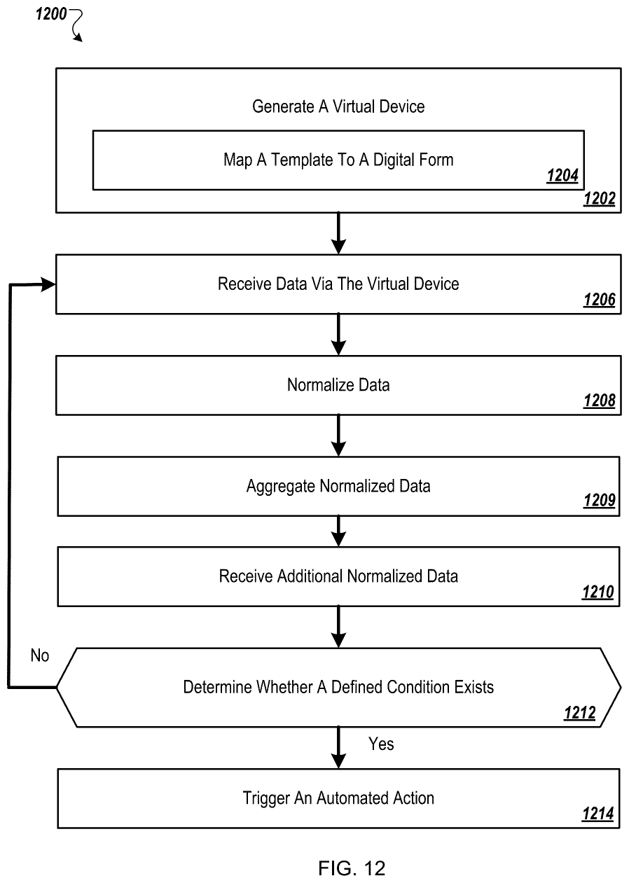

FIG. 12 is a method 1200 of automated environment management, according to at least one embodiment of the present invention. The method 1200 may be implemented in a managed environment or partially managed environment such as a warehouse environment that includes one or more digital devices and at least one analog device. The analog device may not be capable of digital or network communication. For instance, a system implemented to manage the environment may receive data and information via a network (e.g., the network 120). The analog device may have limited or no communication functionality to enable communication of data and information to the system. For example, the managed environment may include a warehouse environment. In this example, the digital devices may include IIOT devices or rugged devices deployed in the warehouse environment. The analog device may include a forklift, a hydraulic lift, a door, or another piece of equipment that does not communicate via a network communication.

The method 1200 may begin at block 1202 in which a virtual device may be generated. The virtual device may be generated in a management system. The virtual device is representative of the analog device. In some embodiments, generation of the virtual device may include block 1204. At block 1204, a template may be mapped. The template may be mapped to a digital form that is configured to receive a manual input related to one or more attributes of the analog device. The digital form may be presented to an operator on one of the digital devices. Data and information related to the attributes of the analog device may be entered or selected on the digital device, which may communicate data representative of the input to the system.

At block 1206, data may be received. The data may be received via the virtual device. For instance, the data may be received from the digital form, which is, through use of the template may be interpreted as received from the virtual device. For instance, the digital form may include an inspection checklist related to the analog device (e.g., a forklift). The one or more attributes may include maintenance items of the analog device such as operational hours, hydraulic pressure, engine operation, tire wear, and the like.

At block 1208, data may be normalized. The data representative of the input entered into the digital form may be normalized. For instance, in some embodiments, the data may be normalized using computing logic of the template. The data may be normalized such that the data is formatted according to a common format that is available to a system implemented to manage an environment. After the data is normalized, it is substantially equivalent to digital data received by one or more of the digital devices.

At block 1209, the normalized data may be aggregated. The normalized data may be aggregated to generate a historical operational record of the analog device. For instance, the digital form may include attributes related to a forklift. The normalized data may include operational attributes related to the forklift over the life of the forklift. The normalized data may be aggregated, which may be indicative an operational history of the forklift.

At block 1210, additional normalized data may be received. The additional normalized data may be received from one or more of the digital devices. In some embodiments, the digital devices may communicate additional data representative of an environment phenomena or an operation in the environment. The additional data may be normalized into the common format such that it can be processed and analyzed with the normalized data from the analog device. For example, the additional normalized data may include scan data from the environment. The scan data may be indicative of item movement in the environment. The scan data may be generated and communicated using a rugged device including a barcode scanner.

At block 1212, it may be determined whether a defined condition exists in the environment. The determination may be based at least partially on the normalized data, aggregated normalized data, the additional normalized data, other information, or combinations thereof. The defined condition may be related to the analog device or related to the environment. In some embodiments, the determination of that the defined condition exists is based at least partially on the additional normalized data and the normalized data. The normalized data may be combined with the additional normalized data (e.g., the scan data) to troubleshoot a cause of a pattern of behavior in the environment in these and other embodiments. For example, the analog device may be used in the item movement in the environment and the pattern of behavior is at least partially attributable to the defined condition. Accordingly, a combination of the normalized data with the additional normalized data may be used to troubleshoot the cause of the pattern. The defined condition may include a technical or an environmental circumstance related to the analog device or the environment. For instance, the defined condition may include a maintenance task of the analog device, a scheduled maintenance task, an acute maintenance task, a delay in an environment management operation, an unsafe environment condition, an inoperable state of the analog device, an inefficient operator, or combinations thereof.

Responsive to the determination that the defined condition exists (“Yes” at block 1212), the method 1200 may proceed to block 1214. Responsive to the determination that the defined condition does not exist (“No” at block 1212), the method 1200 may proceed to block 1206. The method 1200 may continue through one or more of blocks 1206, 1208, 1209, 1210, 1212, and 1214. At block 1214, an automated action may be triggered. The automated action is configured to mitigate or address the defined condition. The automated action may include placing the analog device out of service, initiating a task to replace the analog device, initiating a task to perform a maintenance operation, communicating an alert to a digital device, communicating a modification to an environment management operation, stopping operation of a digital device, modifying a scheduled environment management operation and communicating the modification to a digital device, other automated actions, or combinations thereof.

Although illustrated as discrete blocks, one or more blocks in FIG. 12 may be divided into additional blocks, combined into fewer blocks, or eliminated, depending on the desired implementation. The method 1200 described in the present disclosure may be performed in a suitable operating environment such as the operating environment 100. The method 1200 may be performed by the management system 102, the digital devices 106, another computer device (e.g., 1100 of FIG. 11), or some combination thereof. In some embodiments, the management system 102, the digital devices 106, or another computing system may include or may be communicatively coupled to a non-transitory computer-readable medium (e.g., the memory 1112 of FIG. 11) having stored thereon programming code or instructions that are executable by one or more processors (such as the processor 1110 of FIG. 11) to cause a computing system or the management system 102, the digital devices 106, to perform or control performance of the methods. Additionally or alternatively, the management system 102, the digital device 106, or the computing device may include the processor 1110 described elsewhere in this disclosure that is configured to execute computer instructions to cause the management system 102, the digital device 106, or another computing systems to perform or control performance of the methods.

Further, modifications, additions, or omissions may be made to the methods without departing from the scope of the present disclosure. For example, the operations of methods may be implemented in differing orders. Furthermore, the outlined operations and actions are only provided as examples, and some of the operations and actions may be optional, combined into fewer operations and actions, or expanded into additional operations and actions without detracting from the disclosed embodiments.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of automated environment management including on an analog environment device, the method comprising:
generating a virtual device that is representative of an analog environment device, the generating including mapping a template to at least a portion of a digital form that is configured to receive a manual input related to one or more attributes of an analog environment device;
receiving data from the digital form, the data being interpreted as received from the virtual device;
normalizing data representative of the manual input entered into the digital form such that the data is formatted according to a common format that is available to a system implemented to manage an environment;
based at least partially on the normalized data, determining that a defined condition exists in the environment, wherein the defined condition is related to the analog environment device or related to the environment; and
responsive to the determination, triggering in the system an automated action to address the defined condition.

2. The method of claim 1, further comprising aggregating the normalized data to generate a historical operational record of the analog environment device.

3. The method of claim 1, further comprising receiving additional normalized data from a digital environment device, wherein the determination of that the defined condition exists is based at least partially on the additional normalized data.

4. The method of claim 3, wherein:
the additional normalized data includes scan data from the environment that is indicative of item movement in the environment; and
the normalized data is combined with the scan data to troubleshoot a cause of a pattern of behavior in the environment.

5. The method of claim 4, wherein:
the analog environment device is used in the item movement in the environment; and
the pattern of behavior is at least partially attributable to the defined condition.

6. The method of claim 1, wherein the template provides logic that normalizes the data representative of the manual input such that the normalized data is substantially equivalent to digital data received by one or more digital environment devices.

7. The method of claim 1, wherein:
the digital form includes an inspection checklist related to the analog environment device;
the one or more attributes include maintenance items of the analog environment device; and
the defined condition includes a maintenance task of the analog environment device.

8. The method of claim 1, wherein:
the environment includes a warehouse environment; and
the analog environment device includes a warehouse device that is not capable of digital communication with the system.

9. The method of claim 1, wherein the defined condition includes:
a scheduled maintenance task;
an acute maintenance task;
a delay in an environment management operation;
an unsafe environment condition;
an inoperable state of the analog environment device; or
an inefficient operator.

10. The method of claim 1, wherein the automated action includes:
placing the analog environment device out of service;
initiating a task to replace the analog environment device;
initiating a task to perform a maintenance operation;
communicating an alert to a digital environment device;
communicating a modification to an environment management operation;
stopping operation of a digital environment device; or
modifying a scheduled environment management operation and communicating the modification to a digital environment device.

11. One or more non-transitory computer-readable storage media configured to store instructions that, in response to being executed, cause a system to perform operations of automated environment management including on an analog environment device, the operations comprising:
generating a virtual device that is representative of an analog environment device, the generating including mapping a template to at least a portion of a digital form that is configured to receive a manual input related to one or more attributes of an analog environment device;
receiving data from the digital form, the data being interpreted as received from the virtual device;
normalizing data representative of the manual input entered into the digital form such that the data is formatted according to a common format that is available to a system implemented to manage an environment;
based at least partially on the normalized data, determining that a defined condition exists in the environment, wherein the defined condition is related to the analog environment device or related to the environment; and
responsive to the determination, triggering in the system an automated action to address the defined condition.

12. The non-transitory computer-readable storage media of claim 11, wherein the operations further comprise aggregating the normalized data to generate a historical operational record of the analog environment device.

13. The non-transitory computer-readable storage media of claim 11, wherein the operations further comprise receiving additional normalized data from a digital environment device, wherein the determination of that the defined condition exists is based at least partially on the additional normalized data.

14. The non-transitory computer-readable storage media of claim 13, wherein:
the additional normalized data includes scan data from the environment that is indicative of item movement in the environment; and
the normalized data is combined with the scan data to troubleshoot a cause of a pattern of behavior in the environment.

15. The non-transitory computer-readable storage media of claim 14, wherein:
the analog environment device is used in the item movement in the environment; and
the pattern of behavior is at least partially attributable to the defined condition.

16. The non-transitory computer-readable storage media of claim 11, wherein the template provides logic that normalizes the data representative of the manual input such that the normalized data is substantially equivalent to digital data received by one or more digital environment devices.

17. The non-transitory computer-readable storage media of claim 11, wherein:
the digital form includes an inspection checklist related to the analog environment device;
the one or more attributes include maintenance items of the analog environment device; and
the defined condition includes a maintenance task of the analog environment device.

18. The non-transitory computer-readable storage media of claim 11, wherein:
the environment includes a warehouse environment; and
the analog environment device includes a warehouse device that is not capable of digital communication with the system.

19. The non-transitory computer-readable storage media of claim 11, wherein the defined condition includes:
a scheduled maintenance task;
an acute maintenance task;
a delay in an environment management operation;
an unsafe environment condition;
an inoperable state of the analog environment device; or
an inefficient operator.

20. The non-transitory computer-readable storage media of claim 11, wherein the automated action includes:
placing the analog environment device out of service;
initiating a task to replace the analog environment device;
initiating a task to perform a maintenance operation;
communicating an alert to a digital environment device;
communicating a modification to an environment management operation;
stopping operation of a digital environment device; or
modifying a scheduled environment management operation and communicating the modification to a digital environment device.
